(19) United States
(12) Patent Application Publication
(10) Pub. No.: US 2025/0058416 A1
(43) Pub. Date: Feb. 20, 2025

(54) Selectively-Engageable Fluid-Connection System for CNC Spindle-Mounted Gripper Background

(71) Applicant: Michael Gimbel, Alhambra, CA (US)

(72) Inventor: Michael Gimbel, Alhambra, CA (US)

(21) Appl. No.: 18/805,389

(22) Filed: Aug. 14, 2024

Related U.S. Application Data
(60) Provisional application No. 63/519,653, filed on Aug. 15, 2023.

(51) Int. Cl. B23Q 3/157

(52) U.S. Cl. CPC B23Q 3/15713

(57) ABSTRACT

The present invention pertains to a selectively-engageable fluid-connection system designed for CNC spindle-mounted fluid-actuated gripping devices. The system features a bypass block affixed to the CNC machine, allowing for reliable and efficient coupling/decoupling with the spindle. A specialized fluid connection engages and disengages as the gripper assembly interacts with the spindle. This innovation comprises a tapered cone fluid tube or hemispherical configuration for optimal fluid flow.

### BACKGROUND

### Field of Invention

The present invention relates generally to the field of fluid connection systems for Computer Numerical Control (CNC) machines. More specifically, the invention pertains to a selectively-engageable fluid connection system for a CNC spindle-mounted fluid-actuated gripping devices. One example of such a device is a spindle-mounted Gripper to grip and move workpieces; another example is a spindle-mounted Vacuum-Generator that uses a vacuum and a suction cup to manipulate workpieces.

### Description of Prior Art

CNC machines are widely used in modern manufacturing processes to produce parts by selectively removing material from a workpiece or “stock” according to programmed instructions. In a typical CNC milling or cutting operation, an operator manually loads the workpiece into a clamping device on the machine table, and unloads the finished part after processing.

To automate the loading and unloading of workpieces, some gripper devices that attach to the CNC machine spindle have been developed. Virtually all spindle-mounted grippers are pneumatically actuated via compressed air delivered through the center of the spindle, or hydraulically actuated via pressurized fluid (coolant) delivered through the center of the spindle. However, this “through spindle air” or “through spindle coolant” functionality adds significant cost and complexity to the CNC machine. Machines lacking through spindle air cannot operate conventional pneumatic or hydraulic spindle grippers or other spindle-mounted fluid-actuated devices.

Furthermore, some workpieces are too thin or irregularly shaped to be securely gripped by conventional mechanical grippers. Vacuum Grabbers with suction cup end effectors offer an alternative way to handle such parts by adhering to the surface of the workpiece. However, suction cups require a vacuum source to generate the necessary holding force. This vacuum force has historically been provided via a venturi generator powered via through spindle air, or directly through a vacuum line plumbed directly through the spindle. However, no current solutions exist that enable a CNC machine without through spindle air equipment to operate a Vacuum spindle-mounted device.

There exists a need for a cost-effective fluid connection system that enables the operation of fluid-actuated grippers and part-grabbers on CNC machines without through spindle air or through spindle coolant functionality.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

The present disclosure describes a selectively-engageable fluid-connection system for a CNC spindle-mounted fluid-actuated gripping device. The system comprises a bypass block configured for mounting on a CNC machine, a spindle gripper assembly adapted to couple to and decouple from the machine's spindle, and a fluid connection between the bypass block and spindle-mounted gripping device's assembly that engages when the said assembly is coupled and disengages when it is decoupled.

In various embodiments, the fluid connection may comprise a tapered cone-shaped tube or a hemispherical fluid tube mating with a corresponding spherical cutout. The spindle gripper assembly may include a two-way fluid actuator powered by fluid flow through the connection. A solenoid valve can control fluid flow from a supply connected to the bypass block. The fluid may be compressed air or liquid coolant. In some embodiments, the selective-engageable fluid connection may enable the actuation via vacuum (negative pressure), rather than positive pressure.

Most embodiments can work with a tool-changing apparatus, such as a linear-actuated umbrella-style tool carousel or side-mount tool-changing arm, for coupling and decoupling the spindle gripper assembly.

In some embodiments, a rotary union positioned between a stationary part of the machine and the spindle can allow continuous fluid supply to the gripper assembly during spindle rotation.

The spindle-mounted gripping device may further incorporate a suction cup for part handling. In some embodiments, this vacuum is powered by an integrated venturi generator that itself is powered by positive pneumatic pressure. In other embodiments, the fluid connection system provides vacuum directly to the spindle-mounted gripping device. This configuration enables cost-effective automated workpiece handling on CNC machines lacking through-spindle fluid functionality, while also providing vacuum-based gripping for thin or irregular parts.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is perspective view of an exemplary spindle gripper according to an embodiment of the present invention;

FIG. 2 is a perspective view of the system of FIG. 1 with a second tube for the flow of a fluid;

FIG. 3 is a back view of the system of FIG. 2;

FIG. 4 is a perspective view of the system of FIG. 1 attached to a CNC machine;

FIG. 5 is a perspective view of the system of FIG. 2 attached to a CNC machine;

FIG. 6 is another perspective view of the system of FIG. 4; and

FIG. 7 is a perspective view of an exemplary spindle gripper according to an embodiment of the present invention illustrating the location of an input from an air supply. In other embodiments, note that the air supply can be replaced by a fluid supply, or a negative pressure to draw fluid from the spindle gripper through the bypass block.

FIG. 8 illustrates the interior components of a venturi pump with suction cup for part handling.

FIG. 9 illustrates the exterior of a venturi pump configured to attach to a suction cup for part handling.

FIG. 10 illustrates the venturi pump with suction cup for part handling attached to a CNC machine spindle.

FIG. 11 illustrates the exterior of a venturi pump with suction cup for part handling.

FIG. 12 illustrates a spindle gripper with a rotary union.

FIG. 13 illustrates a cross sectional view of the rotary union.

FIG. 14 illustrates the direction of rotation for the rotary union.

FIG. 15 illustrates a rotary union after rotating according to FIG. 14.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

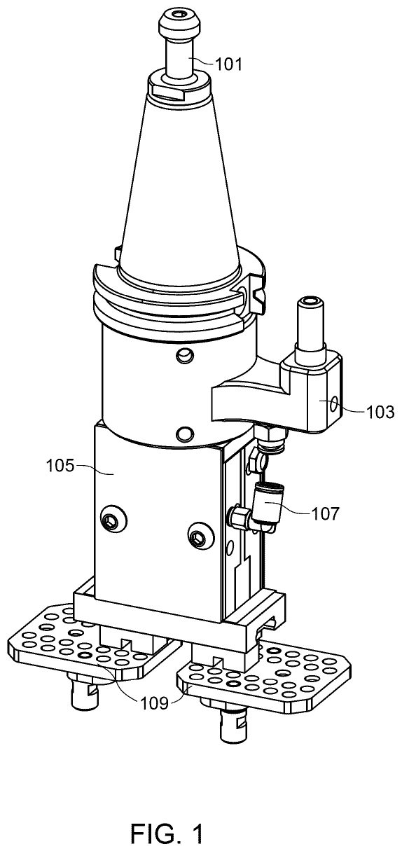

FIG. 1 is perspective view of an exemplary spindle gripper according to an embodiment of the present invention. Bypass connection 103 is configured to be received by a bypass block attached to the CNC machine and to engage and disengage when the gripping device is loaded and unloaded respectively. Inlet 107 is configured for enabling a flow of fluid into or out of the gripper body 105. Gripper body 105 houses a fluid actuator which actuates gripper fingers 109 upon a flow of fluid into or out of gripper body 105. Gripper fingers 109 are configured to make contact with stock to be loaded and machined or processed product to be unloaded. Tool connection 101 is configured to be received and locked into place by a CNC machine spindle.

In embodiments, fluid flow can be configured on either side of a two-way pneumatic or hydraulic actuator, and either side of the actuator can serve as the inlet. Thus, the use of vacuum and negative pressure instead of positive pressure is possible. In other embodiments, fluid flow can be configured with a single-way pneumatic or hydraulic actuator, such a as a solenoid.

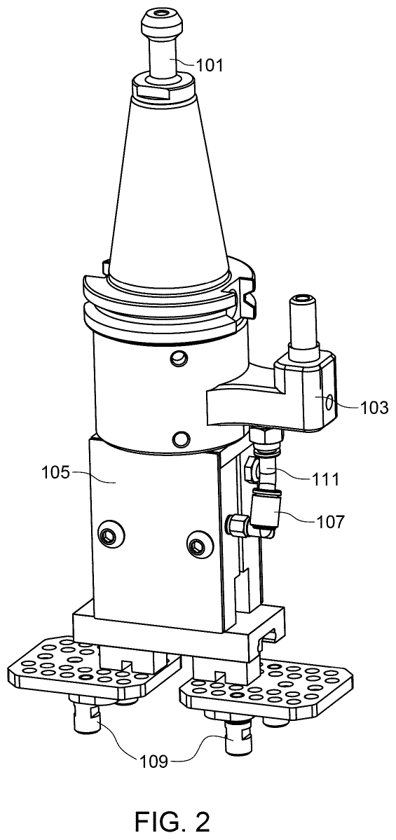

FIG. 2 is a perspective view of the system of FIG. 1 with second tube 111 for the flow of a fluid from bypass connection 103 into or out of inlet 107. As in FIG. 1, fluid can flow into or out of gripper body 105, and gripper body 105 houses a fluid actuator which actuates gripper fingers 109 upon a flow of fluid into or out of gripper body 105. As in FIG. 1, gripper fingers 109 are configured to make contact with stock to be loaded and milled product to be unloaded, and tool connection 101 is configured to be received and locked into place by a CNC machine spindle.

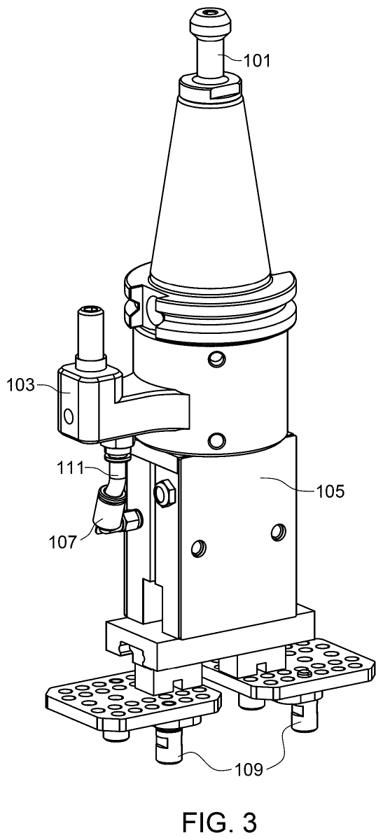

FIG. 3 is a back view of the system of FIG. 2, illustrating the back side of second tube 111 for the flow of a fluid from bypass connection 103 to inlet 107. As in FIG. 1 and FIG. 2, fluid can flow into or out of gripper body 105, and gripper body 105 houses a fluid actuator which actuates gripper fingers 109 upon a flow of fluid into gripper body 105. As in FIG. 1 and FIG. 2, gripper fingers 109 are configured to make contact with stock to be loaded and milled product to be unloaded, and tool connection 101 is configured to be received and locked into place by a CNC machine spindle.

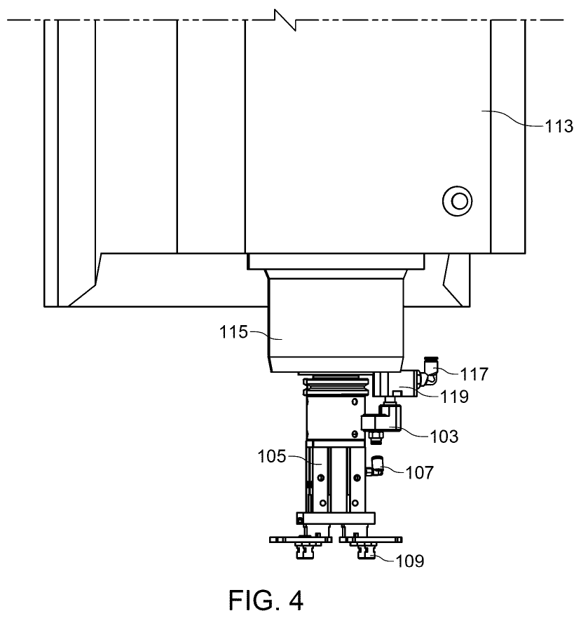

FIG. 4 is a perspective view of the system of FIG. 1 attached to a CNC machine. Tool connection 101 is not visible and is locked inside CNC machine spindle 115. CNC machine spindle 115 is attached to CNC machine housing 113. Bypass block 119 is attached to CNC machine spindle 115 and is configured to receive bypass connection 103. Inlet 117 is configured for enabling a flow of fluid from or to a fluid supply into or out of bypass block 119. Bypass connection 103 is attached to bypass block 119. As in FIGS. 1-3, inlet 107 is configured for enabling a flow of fluid into or out of gripper body 105, and gripper body 105 houses a fluid actuator which actuates gripper fingers 109 upon a flow of fluid into or out of gripper body 105.

In some embodiments, the bypass block would not be connected to the housing, but on another fixed area of the machine, such as the housing for the machine's Z axis.

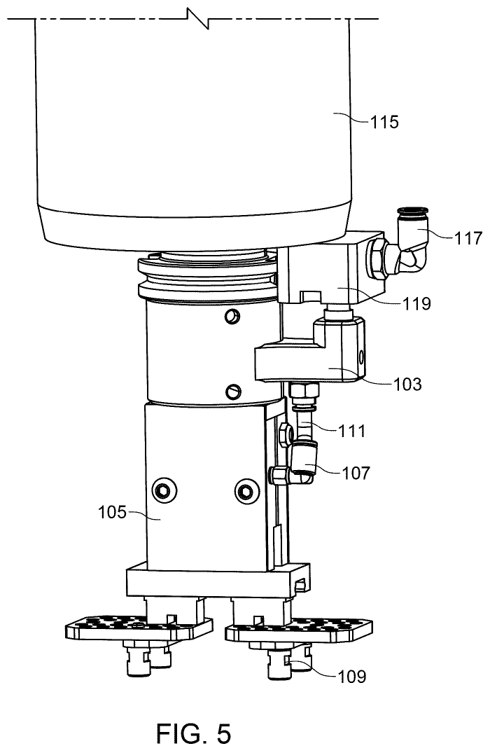

FIG. 5 is a perspective view of the system of FIG. 2 attached to a CNC machine. Second tube 111 is provided for the flow of a fluid into or out of bypass connection 103 to inlet 107. Bypass block 119 is attached to CNC machine spindle 115 and is configured to receive bypass connection 103. Inlet 117 is configured for enabling a flow of fluid from an air supply into bypass block 119. Bypass connection 103 is attached to bypass block 119. As in FIGS. 1-4, inlet 107 is configured for enabling a flow of fluid into gripper body 105, and gripper body 105 houses a pneumatic actuator which actuates gripper fingers 109 upon a flow of fluid into gripper body 105. Fluid can flow in either direction, and for instance, it is possible to actuate a normally closed actuator by flowing air in the opposite direction via vacuum. As in FIG. 4, tool connection 101 is not visible and is locked inside CNC machine spindle 115. CNC machine housing 113 is not shown in this up-close view, but would be positioned above CNC machine spindle 115.

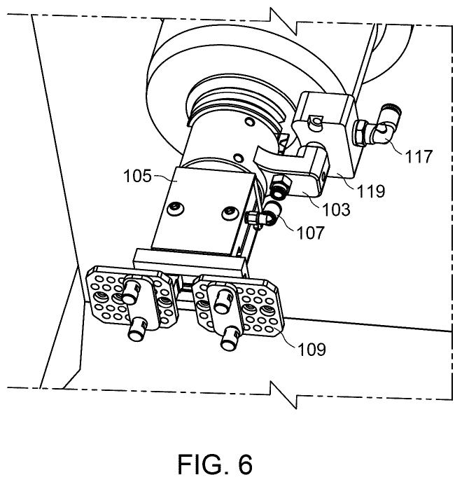

FIG. 6 is another perspective view of the system of FIG. 4 from a bottom vantage point. As in FIG. 4, Tool connection 101 is not visible and is locked inside CNC machine spindle 115 and CNC machine spindle 115 is attached to CNC machine housing 113. Bypass block 119 is attached to CNC machine spindle 115 and is configured to receive bypass connection 103. Inlet 117 is configured for enabling a flow of fluid into bypass block 119. Bypass connection 103 is attached to bypass block 119. As in FIGS. 1-5, inlet 107 is configured for enabling a flow of fluid into gripper body 105, and gripper body 105 houses an actuator which actuates gripper fingers 109 upon a flow of fluid into or out of gripper body 105.

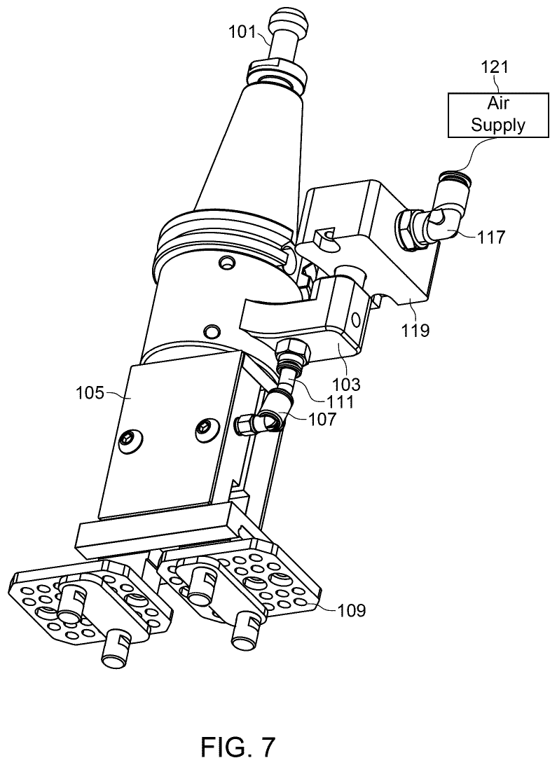

FIG. 7 is a perspective view of an exemplary spindle gripper according to an embodiment of the present invention illustrating a schematic and exemplary location of an air supply or a vacuum (other locations and schemes are possible). Air supply or vacuum 121 is provided to supply or receive fluid to or from inlet 117. Second tube 111 is provided for the flow of a fluid between bypass connection 103 to inlet 107. Bypass block 119 is configured to receive bypass connection 103; a CNC machine spindle is not shown but bypass block 119 is configured to be attached to one. Inlet 117 is configured for enabling a flow of fluid to or from an air supply or vacuum into bypass block 119. Bypass connection 103 is attached to bypass block 119. As in FIGS. 1-6, inlet 107 is configured for enabling a flow of fluid into or out of gripper body 105, and gripper body 105 houses an actuator which actuates gripper fingers 109 upon a flow of fluid into or out of gripper body 105. Tool connection 101 is configured to be locked inside a CNC machine spindle. CNC machine housing 113 and CNC machine spindle 115 are not shown in this view, but bypass connection 103 and tool connection 101 are configured to be attached to a CNC machine spindle positioned above.

In the embodiments depicted in the illustrations described herein, bypass connection 103 and tool connection 101 can engage and disengage when the gripper is loaded and unloaded, and the entire assembly consisting of these elements along with second tube 111 for the flow of a fluid to or from bypass connection 103 to inlet 107, gripper body 105 and gripper fingers 109 can be deposited or retrieved from a tool carousel in the vicinity of the CNC machine spindle.

In embodiments, a gripper tray can be provided. A gripper tray can be used to hold stock for milling by a CNC machine spindle as well as milled parts to be unloaded from the CNC machine spindle. A gripper tray can be positioned according to a work coordinate system stored in a CNC machine computer processor.

In embodiments, a supply of compressed air or vacuum can be provided. A solenoid valve can be additionally provided with the air supply or vacuum. Solenoid valves are electrically operated valves that control a wide range of fluids, including compressed air. A solenoid valve can use electromagnetic levers to help control air release. Solenoid valves are useful for controlling pneumatic equipment, and pneumatic solenoid valves are a natural fit for compressed air applications.

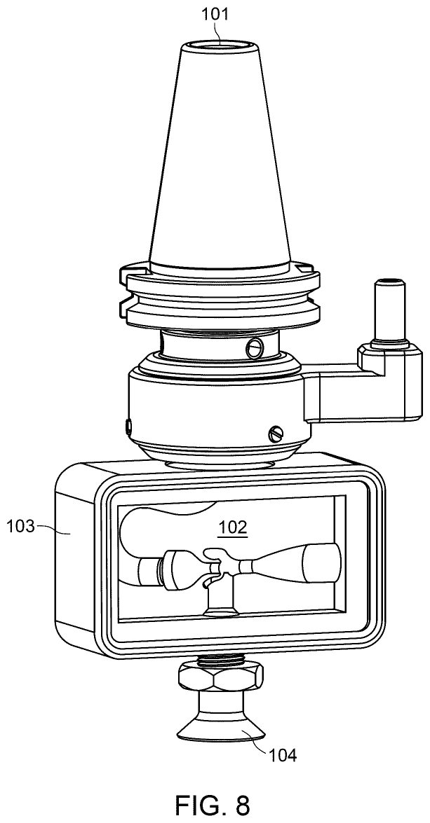

FIG. 8 illustrates the interior components of a venturi pump with suction cup for part handling.

Connection for a spindle 101 is configured to join with the spindle of a CNC machine. Venturi pump 102 is contained within housing 103. Venturi pump 102 creates a vacuum which flows through a channel to suction cup 104. Suction cup 104 is configured to lift a part for handling in the CNC machine.

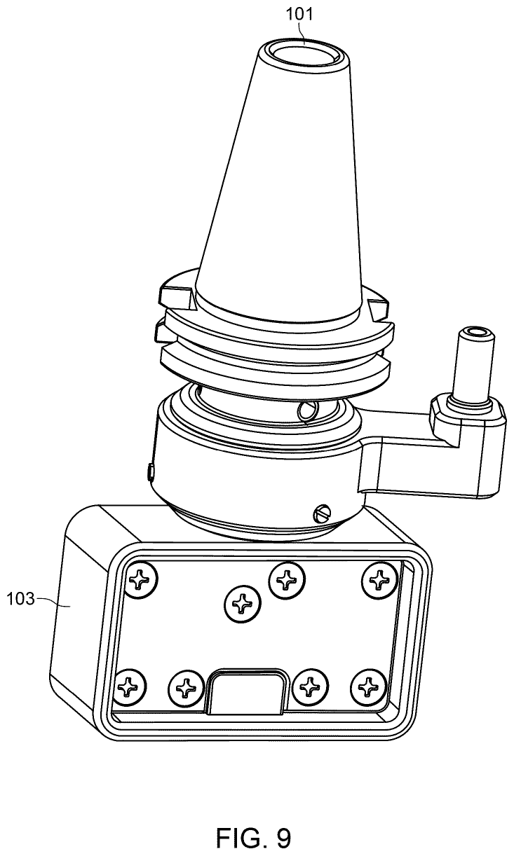

FIG. 9 illustrates the exterior of a venturi pump configured to attach to a suction cup for part handling.

Connection for a spindle 101 configured to join with the spindle of a CNC machine is attached to housing 103. Venturi pump 102 is contained inside the housing and is obscured from view in FIG. 9 by the cap which is screwed on the front of housing 103.

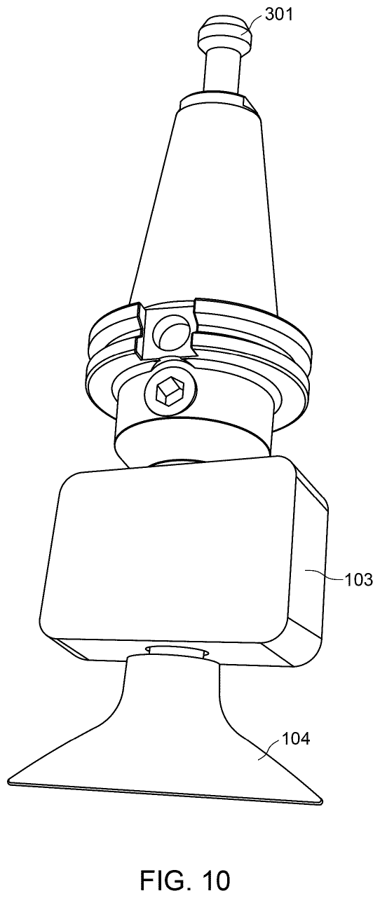

FIG. 10 illustrates the venturi pump with suction cup for part handling attached to a CNC machine spindle.

Spindle 301 connects to housing 103 by the connection for the spindle which is obscured from view in FIG. 3. Suction cup 104 is positioned on the other side of housing 103 from spindle 301. A venturi pump is contained in housing 103 for providing a vacuum allowing suction cup 104 to lift and handle a part.

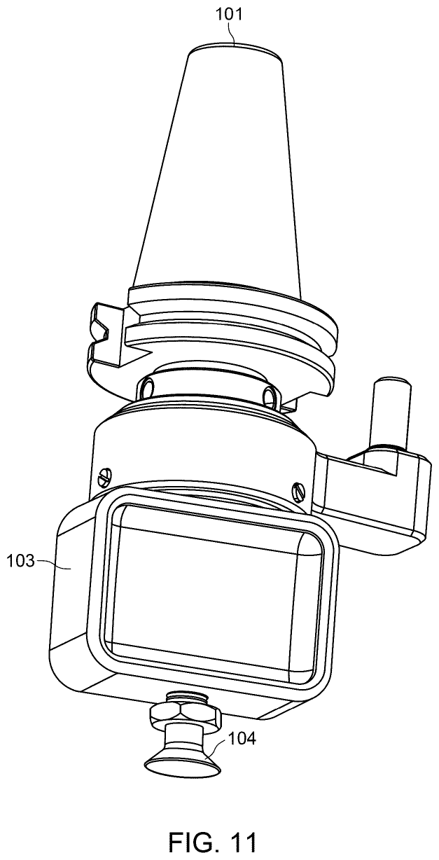

FIG. 11 illustrates the exterior of a venturi pump with suction cup for part handling.

Connection for a spindle 101 configured to join with the spindle of a CNC machine is attached to housing 103. Venturi pump 102 is contained inside the housing and is obscured from view in FIG. 2 by the cap which is screwed on the front of housing 103. The venturi pump is contained in housing 103 for provides a vacuum allowing suction cup 104 to lift and handle a part.

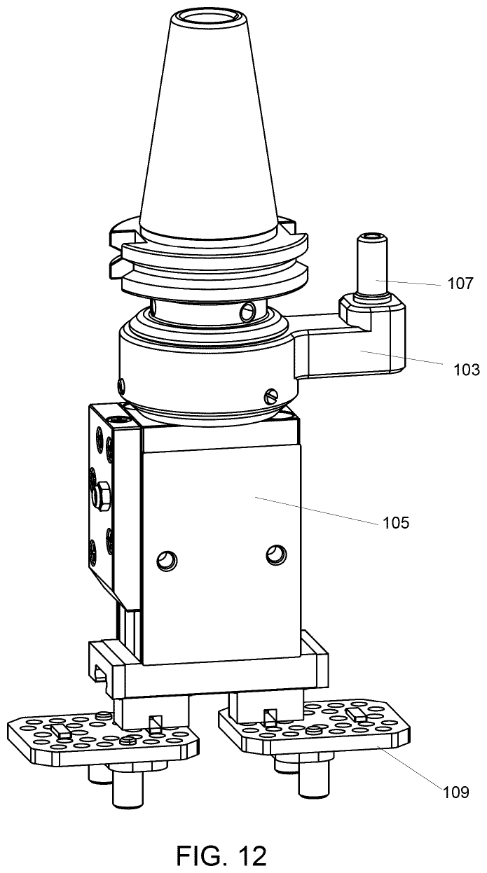

FIG. 12 illustrates a spindle gripper with a rotary union.

In the rotary union, there is no bypass connection configured to be received by a bypass block attached to the CNC machine and to engage and disengage when the gripper is loaded and unloaded respectively. Instead, through spindle-air configured for enabling a flow of fluid into or out of the gripper body 105. Gripper body 105 houses a fluid actuator which actuates gripper fingers 109 upon a flow of fluid into or out of gripper body 105. Gripper fingers 109 are configured to make contact with stock to be loaded and machined or processed product to be unloaded. Now, rotary union 103 is configured to be attached to a tool carousel via connection 107, and rotary union 103 can rotate to give the gripper body 105 an additional axis of freedom.

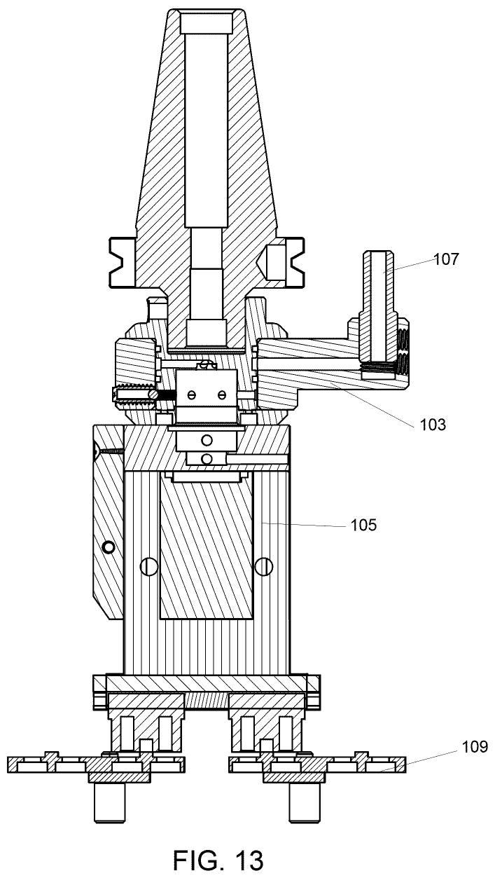

FIG. 13 illustrates a cross sectional view of the rotary union.

In FIG. 13, it can be seen that through spindle-air flows into the gripper body 105. Gripper body 105 houses a fluid actuator which actuates gripper fingers 109 upon a flow of fluid into or out of gripper body 105. Gripper fingers 109 are configured to make contact with stock to be loaded and machined or processed product to be unloaded. Rotary union 103 is configured to be attached to a tool carousel via connection 107, and rotary union 103 can rotate to give the gripper body 105 an additional axis of freedom.

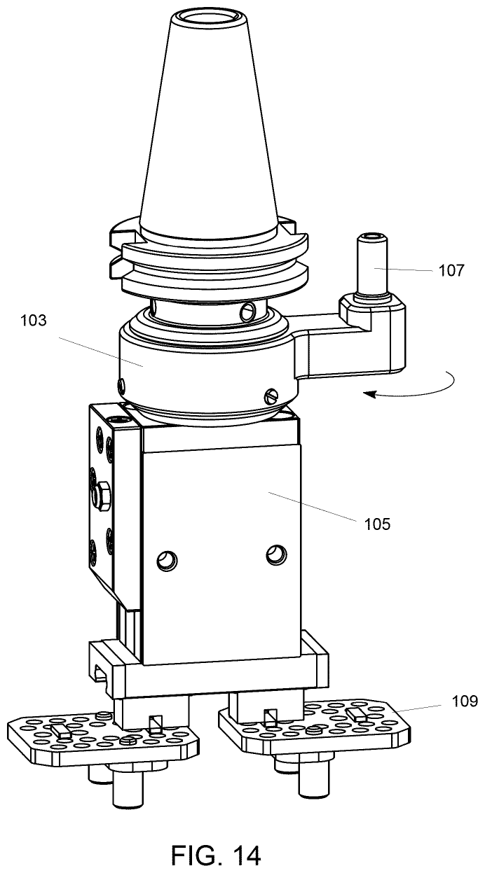

FIG. 14 illustrates the direction of rotation for the rotary union.

The direction of rotation of rotary union 103 is illustrated to give the gripper body 105 an additional axis of freedom. Rotary union 103 is configured to be attached to a tool carousel via connection 107, and rotary union 103 can rotate to give the gripper body 105 an additional axis of freedom. Gripper body 105 houses a fluid actuator which actuates gripper fingers 109 upon a flow of fluid into or out of gripper body 105.

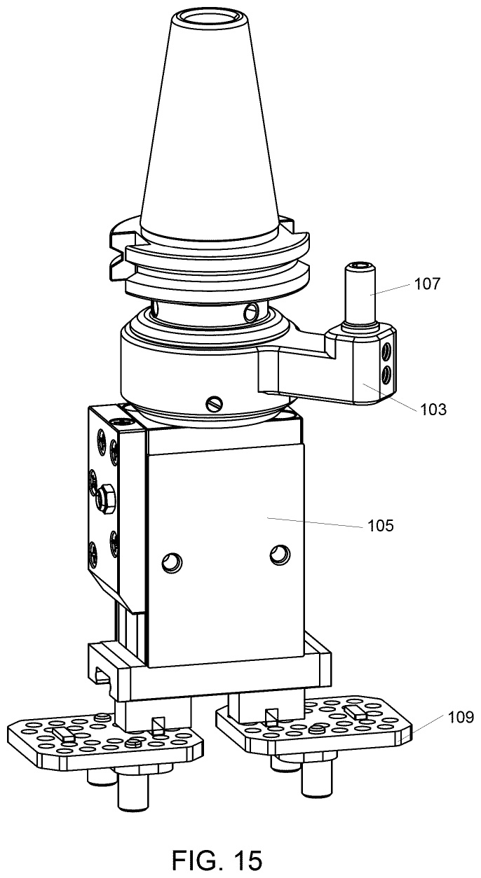

FIG. 15 illustrates a rotary union after rotating according to FIG. 14.

Rotary union 103 is shown rotated compared to FIG. 14. Rotary union 103 is configured to be attached to a tool carousel via connection 107, and rotary union 103 can rotate to give the gripper body 105 an additional axis of freedom. Gripper body 105 houses a fluid actuator which actuates gripper fingers 109 upon a flow of fluid into or out of gripper body 105.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A selectively-engageable fluid-connection system for a CNC spindle-mounted gripping device, comprising: a bypass block configured to be mounted on a CNC machine; a spindle-mounted gripping-device assembly adapted to be coupled to and decoupled from a spindle of the CNC machine; and a fluid connection between the bypass block and the spindle gripping device assembly, wherein the fluid connection is configured to engage when the spindle gripping device assembly is coupled to the spindle and disengage when the spindle gripping device assembly is decoupled from the spindle; wherein the spindle gripping device assembly is actuated by a fluid flowing through the fluid connection between the bypass block and the spindle gripper assembly.

2. The selectively-engageable fluid-connection system of claim 1, wherein the bypass block is configured to be mounted on a CNC machine lacking through-spindle fluid functionality.

3. The selectively-engageable fluid-connection system of claim 1, further comprising: a fluid supply connected to the bypass block, wherein the fluid is supplied from the fluid supply to the spindle gripper assembly via the fluid connection.

4. The selectively-engageable fluid-connection system of claim 3, wherein the fluid is one selected from the group consisting of compressed air and a liquid coolant.

5. The selectively-engageable fluid-connection system of claim 1, wherein the fluid connection comprises: a tapered cone-shaped tube configured to engage and disengage when the spindle gripper assembly is coupled to and decoupled from the spindle, respectively.

6. The selectively-engageable fluid-connection system of claim 1, wherein the fluid connection comprises: a hemispherical fluid tube protruding from one of the bypass block and the spindle gripping device assembly; and a corresponding spherical cutout in the other of the bypass block and the spindle gripper assembly, the spherical cutout configured to mate with the hemispherical fluid tube.

7. The selectively-engageable fluid-connection system of claim 1, further comprising:
a tool-changing apparatus configured to couple and decouple the spindle gripper assembly to and from the spindle, wherein the tool-changing apparatus is one selected from the group consisting of a linear-actuated umbrella-style tool carousel and a side-mount tool-changing arm.

8. The selectively-engageable fluid-connection system of claim 1, wherein the spindle gripper assembly comprises: a two-way fluid actuator configured to be actuated by fluid flow in either direction through the fluid connection.

9. The selectively-engageable fluid-connection system of claim 3, further comprising: a solenoid valve configured to control the fluid flow from the fluid supply to the bypass block.

10. The selectively-engageable fluid-connection system of claim 1, further comprising: a rotary union positioned between a stationary part of the CNC machine and the spindle, wherein the rotary union includes a stationary part connected to a compressed air source and a rotating part connected to a fluid source and a stationary part connected to a fluid inlet port of the bypass block assembly.

11. A CNC machine tool system comprising: a spindle configured to receive a tool holder; a tool changing apparatus adapted to automatically couple and decouple tool holders to and from the spindle; a spindle gripper assembly configured as a tool holder to be coupled to and decoupled from the spindle by the tool changing apparatus; a bypass block mounted on the CNC machine tool; and a fluid connection between the bypass block and the spindle gripper assembly, the fluid connection configured to engage when the spindle gripper assembly is coupled to the spindle and disengage when the spindle gripper assembly is decoupled from the spindle; wherein the spindle gripper assembly includes a gripper actuated by a fluid flowing through the fluid connection between the bypass block and the spindle gripper assembly.

12. The CNC machine tool system of claim 11, wherein the fluid is compressed air.

13. The CNC machine tool system of claim 11, wherein the fluid is a liquid coolant.

14. The CNC machine tool system of claim 11, further comprising: a tool carousel configured to receive the spindle gripper assembly.

15. The CNC machine tool system of claim 11, wherein the spindle gripper assembly includes: a suction cup for part handling, the suction cup being powered by a venturi pump housed within the spindle gripper assembly.

16. The CNC machine tool system of claim 15, further comprising: a channel connecting the venturi pump to the suction cup.

17. The CNC machine tool system of claim 11, wherein the fluid connection comprises:
a tube through which the fluid can flow, the tube being connected from the bypass block to the spindle gripper assembly; wherein the spindle gripper assembly is actuated by the fluid flowing from the bypass block through the tube to the spindle gripper assembly.

18. The CNC machine tool system of claim 17, wherein the tube is a tapered cone-shaped tube configured to engage and disengage with the spindle gripper assembly.

19. The CNC machine tool system of claim 11, wherein the fluid connection comprises: a hemispherical fluid tube protruding from one of the spindle gripper assembly and the bypass block; and
a spherical cutout in the other of the spindle gripper assembly and the bypass block, the spherical cutout configured to mate with the hemispherical fluid tube when the spindle gripper assembly is coupled to the spindle.

20. The CNC machine tool system of claim 11, further comprising: a rotary union positioned between a stationary part of the CNC machine tool and the spindle, wherein the rotary union includes a rotating part connected to a fluid source and a stationary part connected to a fluid inlet port of the bypass block assembly.
